(19) United States
(12) Patent Application Publication
(10) Pub. No.: US 2012/0142310 A1
(43) Pub. Date: Jun. 7, 2012

(54) SYSTEM AND METHOD FOR MANAGING MOBILE DEVICES AND SERVICES

(75) Inventors: Greg Pugh, Columbus, OH (US); Sarah Coles, Mount Sterling, OH (US); Rick Slawinski, Columbus, OH (US); Jason Fisher, Delaware, OH (US); Will Nankivell, Grove City, OH (US); Erica Oliver, Cincinnati, OH (US)

(73) Assignee: INTEGRATED MOBILE, INC., Columbus, OH (US)

(21) Appl. No.: 12/520,464

(22) PCT Filed: Dec. 21, 2007
(86) PCT No.: PCT/US07/88732

§ 371 Date: Jan. 18, 2011

Related U.S. Application Data
(60) Provisional application No. 60/871,653, filed on Dec. 22, 2006.

(51) Int. Cl. H04W 4/26; H04W 4/24; H04W 4/00

(52) U.S. Cl. 455/406; 455/414.1; 455/405

(57) ABSTRACT

The mobile device management system provides for administration of mobile devices associated with a customer and supported by multiple service providers or carriers. The system provides a central, customized interface for management of mobile devices. The system aggregates customer policies, service plan information from various service providers and specific end user information to enable management of mobile devices. Management functions include procurement, expense management, billing and invoicing, support and monitoring of mobile devices associated with the customer. This system and method for managing mobile devices and services keeps the customers mobile workforce connected while reducing the total cost of ownership.

### CROSS-REFERENCE TO RELATED APPLICATIONS

This application claims the benefit of U.S. provisional Application Ser. No. 60/871,653, entitled, “System and Method for Managing Mobile Devices and Services,” filed on Dec. 22, 2006.

### BACKGROUND OF THE INVENTION

### Related Art

Mobile communications and wireless connectivity are affordable to the vast majority of the population. Mobile devices have become an essential, ubiquitous element of today's business environment. Customers expect to be able to quickly reach the person they are calling, even when that person is not, for example, at their desk. Employers rely on being able to communicate with their employees at all times during the work day and often outside of traditional business hours as well.

Many companies therefore provide cell phones or wireless devices to their employees as part of their employment package. However, the large number of cell phone service providers, the myriad of service offerings and package deals now available, and the constant stream of new wireless devices coming from cell phone manufacturers have made it increasingly difficult for companies to do this effectively. As used herein, the term “service provider” refers to an entity or organization that provides support for mobile devices, such as a wireless carrier that operates a network for mobile phones.

More often than not, there is not a single mobile device and service plan that would serve all employees adequately. Rather, individual employees have widely varying needs based upon their individual job requirements and personal preferences. One employee may require only a basic cell phone. Other employees may require PDAs, wirelessly equipped laptops, pagers, or combinations of devices depending on their individual needs. Some companies have employees that travel internationally and therefore it might be in the company's best interest to use a service provider whose network is compatible with the International GSM standard. Other companies might save money by forgoing international or nationwide coverage and use only a local reseller's network.

For budgetary reasons, employers often restrict employees to a particular subset of phones, such as those provided free with service plan commitments. Employees pay extra to upgrade to an enhanced phone with a camera, mp3 player, or other desired feature. For network compatibility reasons, employees may be restricted to certain service providers or phones, for example those compatible with the company's Good Technology® or Microsoft Exchange® email platforms.

Employees differ in their typical usage patterns. Some employees require only a simple voice plan, while others may require, a data plan, text messaging, or even push-to-talk capability. A company can purchase bulk minutes to be shared among employees, or it may be more cost effective to purchase individual plans with a larger number of minutes and unlimited data usage for designated high usage employees. Billing is also an important consideration, as offices and business units may require individualized billing for employees in their groups. Breaking apart bills or inflexible billing that does not allow employees to easily move from one group to another as they are promoted or transferred can create unnecessary financial difficulties. Consequently, management of mobile devices, service plans and related issues quickly becomes a complex, costly, and time-consuming issue for many organizations.

### SUMMARY

The following summary is intended to provide a simple overview as well as to provide a basic understanding of the subject matter described herein. It is not intended to describe or limit the scope of the claimed subject matter. Furthermore, this summary is not intended to describe critical or key elements of the claimed subject matter. Additional aspects and embodiments are described below in the detailed description.

The subject matter described herein is directed to methods and systems for facilitating mobile device management. The device management system provides for centralized administration of mobile devices for a mobile device customer. In particular, the system provides for managing large numbers of mobile devices supported by multiple service providers with varying service plans. Service provider data, such as available service plans, devices, offers, discounts, and the like, is utilized in conjunction with customer data to manage procurement, allocation, distribution, support and/or billing for mobile devices for mobile device customers and end users of the mobile devices.

In certain embodiments, the system includes a procurement component that obtains mobile devices from a plurality of service providers in accordance with customer policies. In particular, end users utilize a customizable user interface to place orders and track shipment of mobile devices. In another embodiment, the procurement component complies with customer approval processes, obtaining appropriate authorizations prior to procurement of mobile devices.

In other embodiments, the device management system includes a billing component that aggregates invoicing and usage information from multiple service providers and allocates costs in accordance with customer policies. In an embodiment, costs are allocated based upon customer business unit. In another embodiment, costs are allocated both to the customer and to individual users as a function of service plan or function.

### BRIEF DESCRIPTION OF THE DRAWINGS

The claimed subject matter is described with reference to the accompanying drawings. In the drawings, like reference numbers indicate identical or functionally similar elements. Additionally, the left-most digit(s) of a reference number identifies the drawing in which the reference number first appears.

FIG. 1 is block diagram of a system that manages mobile devices in accordance with an aspect of the subject matter described herein.

FIG. 2 is a block diagram of another embodiment of a system that manages mobile devices in accordance with an aspect of the subject matter described herein.

FIG. 3 is a block diagram of another embodiment of a system that manages mobile devices illustrating system inputs and output in accordance with an aspect of the subject matter described herein.

FIG. 4 is a detailed block diagram of the procurement component in accordance with an aspect of the subject matter described herein.

FIG. 5 is an exemplary methodology for managing a mobile device orders in accordance with an aspect of the subject matter described herein.

FIG. 6 is an exemplary methodology for updating the asset data store in accordance with an aspect of the subject matter described herein.

FIG. 7 is a detailed block diagram of an exemplary asset component in accordance with an aspect of the subject matter described herein.

FIG. 8 is an exemplary methodology for optimizing mobile device management in accordance with an aspect of the subject matter described herein.

FIG. 9 is an exemplary methodology for optimizing mobile device management in accordance with an aspect of the subject matter described herein.

FIG. 10 is a detailed block diagram of an exemplary support component in accordance with an aspect of the subject matter described herein.

FIG. 11 is a flowchart illustrating an exemplary methodology for providing support for mobile devices in accordance with an aspect of the subject matter described herein.

FIG. 12 is a flowchart illustrating an exemplary methodology for monitoring support in accordance with an aspect of the subject matter described herein.

FIG. 13 is a detailed block diagram of an exemplary billing component in accordance with an aspect of the subject matter described herein.

FIG. 14 is a flowchart depicting an exemplary methodology for transforming service provider information in accordance with an aspect of the subject matter described herein.

FIG. 15 is a flowchart depicting an exemplary methodology for processing service provider invoices in accordance with an aspect of the subject matter described herein.

FIG. 16 is a flowchart that depicts an exemplary methodology for configuring the device management system for a customer in accordance with an aspect of the subject matter described herein.

FIG. 17 is a flowchart depicting an exemplary methodology for configuring the user interface for a customer in accordance with an aspect of the subject matter described herein.

### DETAILED DESCRIPTION

As described above managing mobile devices is a complex problem for many organizations. Service providers typically offer multiple service plans and device options, which vary in the type of services provided, usage rates, coverage areas, device requirements and capabilities, and other features. Large organizations or organizations with diverse needs may select multiple service plans offered by one or more carriers in order to meet the needs of its employee end users. In particular, an organization may elect to utilize multiple carriers, selecting different carriers for distinct regional offices, for individual functions, based upon user preference, corporate Information Technology (IT) policy, or any other criteria. Additionally, organizations frequently offer a specific set of paid services for one category of employees, agents, or other persons or entities designated to receive mobile devices and services (e.g., technical support, upper level management or sales people), collectively referred to as end users, but offer more limited services to other categories of end users. Management of mobile devices, service plans and related issues quickly becomes a complex, costly, and time-consuming issue for organizations.

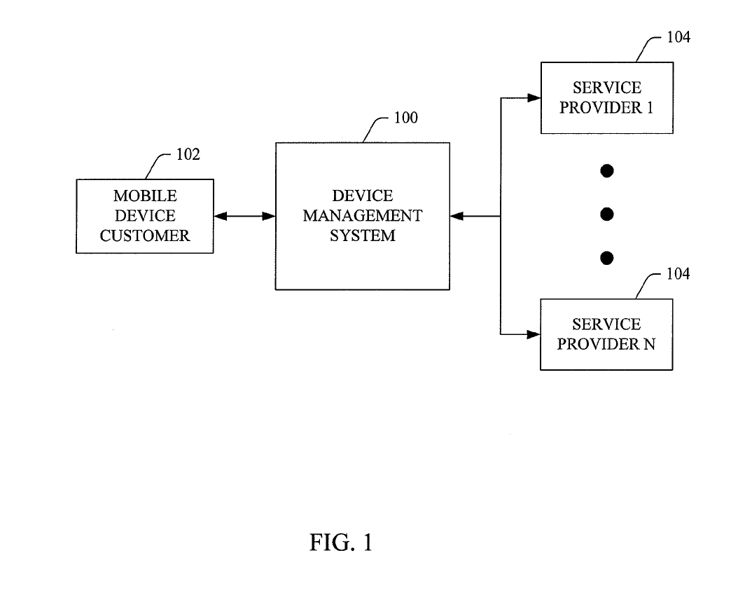

Turning now to FIG. 1, an exemplary device management system 100 that provides for centralized administration of mobile devices for one or more customers 102 is illustrated. As used herein, the term “exemplary” indicates a sample or example. It is not indicative of preference over other aspects or embodiments. The term “mobile device” refers to cellular phone, PDA, laptop, wireless data card, smart phone, or any other device capable of wireless communication. Also, as used herein, the term “customer” indicates an entity, business, organization or other logical group of mobile device end users. In addition, the term “customer entity” and “customer” are used interchangeably herein. Typically, mobile device customers 102 utilize the device management system 100 to manage mobile device services obtained from multiple service providers. A single customer 102 is illustrated in FIG. 1 for simplicity; however, in another embodiment, the system 100 is capable of supporting multiple customers 102, and a single customer 102 may also comprise multiple organizations, for example, a subsidiary and parent or a group of affiliated companies with a common IT support and procurement organization.

In an embodiment, the device management system 100 adapts or customizes to conform to customer policies. As used herein, the term “customer policy” is a procedure, practice, strategy, business process, goal or business requirement of a customer 102. Customers 102 provide information regarding internal policies or procedures related to mobile devices, such as requirements for distribution of mobile devices, acceptable use of such devices, billing requirements, end user requirements, provisioning procedures, support procedures and requirements, and the like. The provided information is utilized or incorporated into the device management system 100 to ensure that mobile devices are managed in accordance with the needs and standards of the customer 102. In another embodiment, the device management system 100 supports multiple customers 102, where the policies obtained from customers 102 are used to adapt the device management system 100 for particular customers 102, resulting in each customer 102 receiving customized service provided by a unique combination of one or more service providers 104.

The device management system 100 obtains service provider data or information from one or more service providers 104. In one embodiment, the service provider data includes information regarding available service plans, devices, offers, discounts, and the like. Such information is utilized in conjunction with customer data to manage allocation, distribution, support and/or billing for mobile devices for customers 102 and other end users. In an embodiment, the service provider information includes information specific to a particular customer 102 that is predicated on specific sonic volumes. For example, a discounted rate negotiated by the customer 102. In addition, service provider information applicable to multiple customers 102 is reused, where the device management system 100 supports multiple customers 102. The service provider information also includes usage and billing data associated with the customer's 102 mobile devices and services. As used herein the terms “wireless devices” or “mobile devices,” unless explicitly stated otherwise, includes both the mobile device hardware (e.g., the mobile phone) and the service plan associated with that mobile device hardware. Such service provider information is utilized in administration, billing and optimization of mobile devices for customers 102.

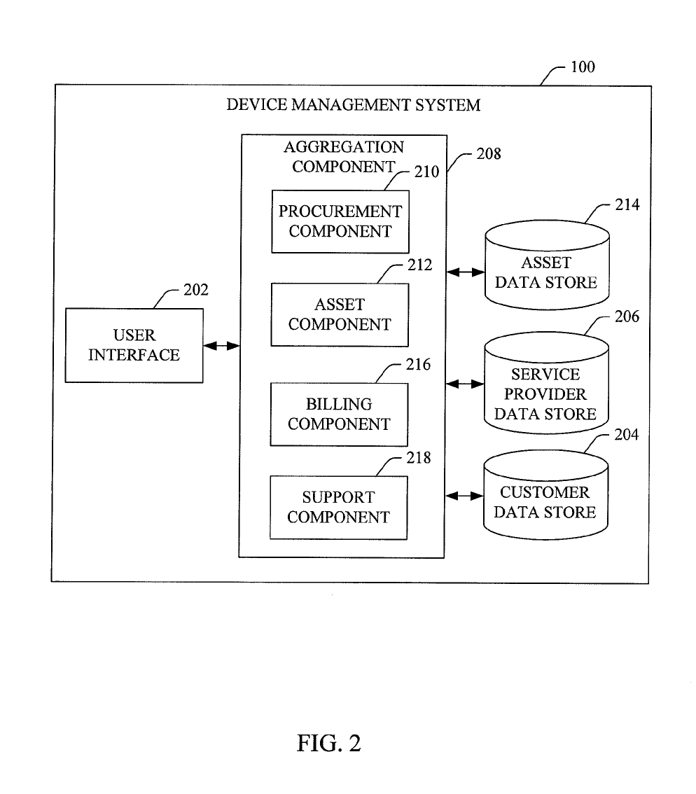

In an embodiment, the device management system 100 is supported by a third party operator, which provides a single interface through which customers 102 manage mobile devices associated with multiple service providers. Customers 102 communicate with the device management system 100 using various modes of communication, such as voicemail, help desk, email, an Internet website, mobile device portal, or other user interface 202 (see FIG. 2). In one embodiment, the device management system 100 serves as a single point of contact for all mobile device issues, eliminating the necessity of determining the appropriate contact for various problems or issues.

The device management system can be implemented in a client-server model computing environment (e.g., two-tier or multi-tier model). In particular, customers and service providers can correspond to clients, where the device management system corresponds to a server. Possible communications can be in the form of data packets transmitted among the clients and servers.

Referring now to FIG. 2, a more detailed block diagram of a device management system 100 is illustrated. The device management system 100 includes a user interface 202 with which customers 102 can access and direct mobile device management. In an embodiment, the user interface 202 is customized based upon the customer 102 and/or the particular end user or class of end user (e.g., administrator, executive, sales personnel) utilizing the user interface 202. Using the login information or user credentials, the user interface 202 filters or hide options, ensuring that only those tools, features, and options available to a particular end user, as determined based upon customer data describing customer policies and practices and relevant service provider data.

In an embodiment, the user interface 202 is provided as a web application or set of applications accessible via a network, such as the Internet. The user interface 202 acts as a web portal that provides customers 102 and end users with a central location to access information related to multiple service providers 104 as well as multiple tools for use in procuring, billing, and managing mobile devices and can be customized to include customer branding. The content of the user interface 202 is adaptable based upon customer policies or practices. In an embodiment, the user interface 202 presents users with customer specific text, such as an Acceptable Use Policy (AUP) or response to frequently asked questions (FAQs). In addition to the text presented, the user interface 202, in some embodiments, is adapted to present or collect data from users as a function of customer policies and practices. For example, a customer can define a policy describing a requirement that a particular category of end user, such as salesperson, always get a mobile device with wireless e-mail capabilities. In which case, when an end user who is a salesperson logs on to the system, the user interface 102 will only provide mobile device options with wireless e-mail capability. Although the user interface 202 is illustrated as a single component, the interface can be implemented as one or more distinct interfaces. For example, separate interfaces may be maintained for procurement and asset management.

In an embodiment, the device management system 100 includes a customer data store 204 that maintains information related to the procedures, policies and practices of one or more customers 102. This information allows the user interface 202 and other components to provide functionality specific to particular customers 102. As used herein, the term “data store” refers to any collection of data (e.g., a database, collection of files or cache). In particular, the customer data store 204 maintains data such as particular device or service provider options available to the customer 102, and customer billing address and/or delivery addresses. Other service provider information can include, contact information, such as service provider representatives.

In certain embodiments, the customer data store 204 maintains organizational information as well as end user information for one or more customers 102. End user information is any data related to a customer's end users, including, but not limited to, end user position, password, access permissions, location, business unit, department, an exhaustive audit trail for the user account including moves, adds, changes, and deletes (MACDs). Organizational information includes information regarding business units, individual end users, positions, departments or any other information related to the structure or management of the organization. Such organizational information in some embodiments is utilized to provide customized functionality, ensuring that end users are provided with the appropriate access and options. For example, a salesperson ordering a new cell phone is limited to the specific devices and service plans for which sales personnel are authorized. At the same time, end users that are members of the accounting department are granted access via the user interface 202 to functions that provide for generation of reports, data and/or statistics related to cell phone usage throughout the customer 102 or a business unit or other business organizational component associated with the customer 102. The detailed customer information maintained in the customer data store 204 facilitates the device management system 100 to tailor access, functionality and reports while optimizing mobile device use while minimizing costs within the constraints of the customer's IT policies and procedures.

The device management system 100 includes a service provider data store 206 that maintains service provider information associated with multiple service providers 104. Service provider information includes, among other details, details of specific service plans and mobile devices offered by the service providers 104. For example, service plans vary in function offered (e.g., data access, voice, voicemail, text messaging, mobile data services, and email), fee policies (e.g., fixed fee, limited usage, overage charges), coverage area, calling plans, calling restrictions, and the like. In addition, service provider information includes fees, rates, discounts and the like. In an embodiment, service provider information includes service plan, mobile device, billing or other options specific to one or more customers 102. For example, a customer 102 may negotiate with the service provider 104 for better rates based upon, for example, the number of end users, volume of calls made, or data transmitted or number of mobile devices.

An aggregation component 208 utilizes service provider data obtained from the service provider data store 206 combined with customer data obtained from the customer data store 204 to facilitate administration of mobile devices for customers 102. As used herein, the term “component” includes hardware, software, firmware or any combination thereof. For example, a component may be, but is not limited to being, a process running on a processor, or alternatively, the processor itself. Further, a component can be localized in a single computer or server, or distributed among two or more computers. The aggregation component 208 coordinates customer policies reflected in the customer data and service plan specifications obtained from multiple service providers 104 to assist the customer 102 in administering distribution, cost allocation, support and monitoring of mobile devices for end users associated with the customer 102. In another embodiment, the aggregation component 208 also utilizes end user data, such as end user position, location, business unit, department, an exhaustive audit trail for the user account including moves, adds, changes, and deletes (MACDs), as well as any other relevant end user information for administration of mobile devices. The aggregated service provider, customer data and end user data is useful for a number of functions that facilitate management of mobile devices, including, but not limited to, procurement of mobile devices, billing or invoicing for such devices and associated services, tracking mobile devices within a customer's organization and/or providing support for mobile devices.

In one embodiment, the device management system 100 includes a procurement component 210 that coordinates mobile device orders provisioning and distribution. Customers 102 access the procurement component 210 via the user interface 202 to place for orders for mobile devices and to track shipments of such devices. The procurement component 210 utilizes customer 102 and service provider 104 specific information to control device ordering, ensuring that mobile device selections are consistent with customer policies and service provider service plans. For example, the procurement component 210 utilizes customer data from the customer data store 204 to ensure that only those mobile devices or service plans approved by the customer 102 in accordance with customer's wireless policy are presented for selection by a user. The procurement component 210 utilizes provider service plan pricing that has been negotiated with the service providers 104.

In another embodiment, the procurement component 210 is customized based upon the specific individual or end user utilizing the procurement component 210. As described above, the procurement component 210 provides different mobile device options based in part upon the characteristics of the end user, such as end user data. For example, customer policies may provide for different mobile devices or service plans based upon characteristics of the end user, such as position within the organization, business unit, length of service and the like. In another embodiment, end users that act as mobile device system administrators for the customer 102 may have access to additional functions in the device management system 100, such as monitoring mobile device distribution across business units or approval of order requests or have their contact details forwarded to a service provider 104 as the designated contact. Other end users may be limited to narrower functions, such as ordering a device for their personnel use, or reviewing use and history unique to themselves.

In other embodiments, the procurement component 210 and user interface 202 ensure that a customer specific procurement process is followed in ordering mobile devices, as specified in customer data reflecting the customer's policies and procedures. For example, a customer 102 requires approval or authorization by specific individuals or departments before orders for mobile devices or services are placed with a service provider 104. Based upon customer data maintained in the customer data store 204, the procurement component 210 determines the appropriate individual, department or email address to contact for approval prior to placing the order with the appropriate service provider. In this manner, the device management system 100 is able to generate, follow, and administer the business process necessary to comply with IT policy and procedures. In a further embodiment, the procurement process is specific to the particular end user ordering a mobile device. For example, the manager of the end user may be required to approve the order. Alternatively, certain end users (e.g., executives) may not be required to obtain approval.

In another embodiment, the device management system 100 includes an asset component 212 that provides for monitoring and managing mobile device assets of customers 102. By accessing the asset component 212 via the user interface 202, selected end users obtain information regarding distribution and use of mobile devices for the customer 102. The asset component 212 is also used to generate reports indicating exceptional use characteristics, usage statistics, distribution characteristics and the like for both individual users and in the aggregate for groups of end users.

The asset component 212 accesses data maintained in an asset data store 214 to analyze, process and provide data to end users. In an embodiment, the asset data store 214 maintains information regarding the customer's mobile devices, including, but not limited to, information regarding employees that currently have access to specific assets, length of time employees have had assets, business unit and/or title of the employee holding the asset, billing and usage data, and the like. In another embodiment, package slips, invoices or any other forms associated with a mobile device are stored in the asset data store 214. In yet another embodiment, the asset data store includes data regarding mobile device connection cards and accessories (e.g., ear buds, Bluetooth accessories and the like). The asset data store 214 maintains such data for mobile devices or assets obtained from multiple service providers 104. Collection of such data at a central location facilitates analysis and optimization of utility and use of mobile devices, while controlling or minimizing costs.

In a further embodiment, the device management system 100 includes a billing component 216 that directs billing and invoicing for mobile devices. Invoices and/or usage data from one or more service providers 104 is obtained by the device management system 100 and stored in the service provider data store 206. In one embodiment, the billing component 216 utilizes the aggregate information maintained in the service provider data store 206 to generate invoices. Invoice and/or usage data from multiple service providers 104 can be combined, separated based upon business unit, service type (e.g., voice & data) or any other criteria useful to the customer 102. For example, employees may be billed for certain portions of their mobile device expenses (e.g., personal phone calls, additional functions). In an embodiment, customer policies define generation of separate invoices based upon aggregated information from multiple service providers. In addition, end users may utilize the billing component 216 to view, sort and analyze billing and usage patterns. In another embodiment, the billing component 216 is capable of automatically paying service provider invoices.

In still another embodiment, the device management system 100 includes a support component 218 that manages provision of support for mobile device users and/or administrators. Support may include responses to end user or administrator questions, reporting and correction of technical problems with a mobile device or service, and even replacement mobile devices. The support component 218 provides a central source to obtain support for mobile devices provided by multiple service providers 104. In particular, users can access the support component 218 via the user interface 202, which may include a web site or application, a help desk, or any other means of communication.

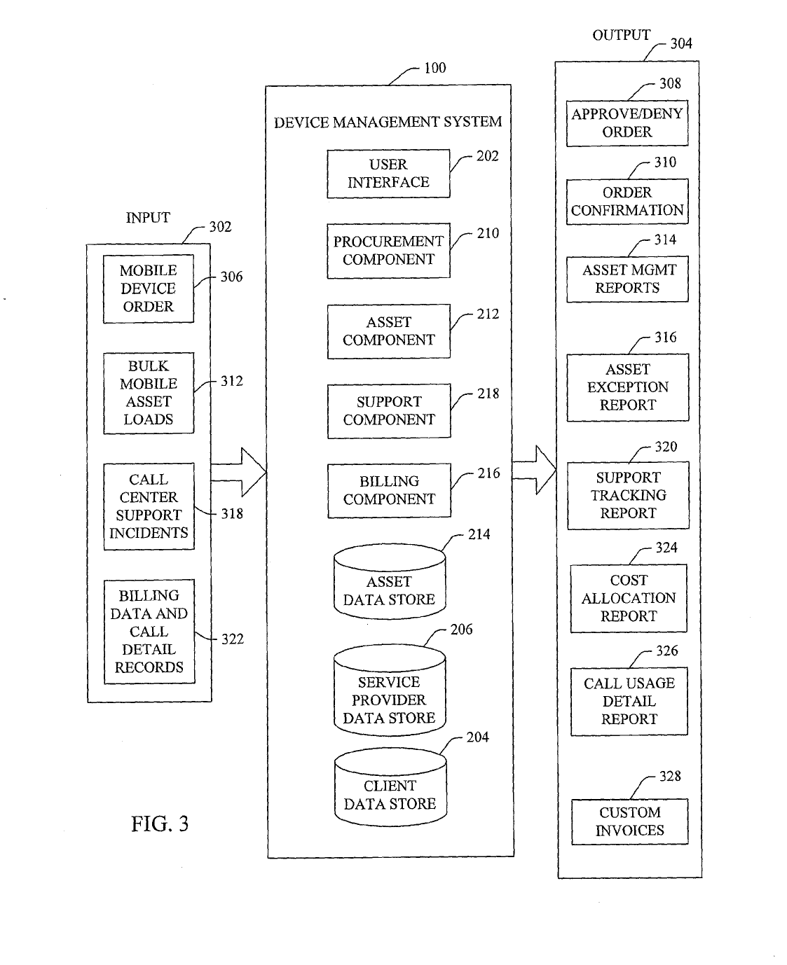

Turning now to FIG. 3, another embodiment of the device management system 100 is illustrated, depicting inputs 302 and outputs 304 of the device management system 100. The illustrated inputs 302 and outputs 304 are merely exemplary; additional inputs 302 and outputs 304 can be provided to the system 100 and/or generated by the system 100. Inputs 302 are communicated to the device management system 100 using a variety of methods, such as via a network (e.g., the Internet), over a telephone system, text messaging or using any other suitable means of communication or transfer of information.

In an embodiment, inputs 302 to the device management system 100 include wireless orders or mobile device orders 306. In particular, end users associated with a customer 102 utilize the device management system 100 to order mobile devices, such as cell phones or service plans. In particular, end users utilize the user interface 202 to access the procurement component 210 and select from available options. In another embodiment, only options available to the particular end user are displayed. End users access the user interface 202 utilizing identifiers and/or passwords that identify and authorize user access. Based upon information retrieved from the customer data store 204 regarding the particular end user or user traits (e.g., business unit, position in the company, etc.), the user is provided with a customized list of mobile device and service plan options. Available options are also determined based upon available service plans of various service providers 104. In another embodiment, the set of available options are reduced by filtering available options by the customer policy for an end user with the characteristics of the end user accessing the user interface 202. In still another embodiment, the set of available options presented to the end user is ordered based upon criteria such as total ownership cost for the customer 102. In an embodiment, the mobile device options presented to an end user by the user interface 202 are based upon customer data, service provider and end user data.

In response to the mobile device order 306, the user receives a communication 308 approving or denying the mobile device order. As discussed above, in certain embodiments, the procurement component 210 utilizes customer practices and policies, including customer approval procedures required for procurement of a mobile device, to review, oversee, and approve the procurement of mobile devices. The procurement component 210 retrieves information regarding the particular customer 102 and/or end user from the customer data store 204. Based upon the retrieved customer policies and authorization or denial from an appropriate party, the approval or denial communication 308 is communicated to the end user. In one embodiment, the denial communication is accompanied by a request for additional information and includes a link or form for the end user to submit or input such additional information. For example, approval can be delivered via email, voicemail, or any other suitable means of communication. If the order is approved, the end user may be provided with a confirmation notice 310 once the order is placed with the appropriate service provider 104.

In another embodiment, the device management system 100 receives a bulk mobile asset load 312 as input 302. During initial setup or customization of the device management system 100 for a customer 102, mobile device records are processed in bulk or batches and added to the asset data store 214. The bulk mobile asset load 312 data may require reformatting or merely a customized mapping or input filter to sort the data to the appropriate fields with the asset data store 214 and can be provided as an electronic file or set of files. The information is parsed and transformed into the device management systems 100 standard format by the asset component 212. The reformatted data is then stored within the asset data store 214. As additional mobile devices are added by the procurement component 210, the data related to the new mobile devices is stored in the asset data store 214. Contemporaneous to loading of mobile device information, customer policies, procedures, organizational information and other data related to the customer 102 is uploaded or entered into the customer data store 204.

In other embodiments, end users obtain or receive mobile asset management reports 314 that provide customers 102, users and administrators with data regarding distribution and usage of mobile devices by the customer 102 and the customer's end users. The information can be presented in a variety of formats to assist customer 102 in monitoring and managing mobile devices. In an embodiment, reports 314 describing asset distribution and usage are generated periodically or dynamically at the request of an administrator or end user. The reports 314 can be used to optimize utility of mobile device distribution and can be distributed through email, traditional hard copy or using any other suitable method of communication.

In still another embodiment, customer administrators obtain or receive asset exception reports 316. These exception reports 316 describe instances of usage that may be particularly useful in optimizing mobile device use and minimizing mobile device fees. For example, exception reports 316 can list mobile devices or end users incurring the largest roaming charges or exceeding minute limitations. In yet another embodiment, the exception reports 316 provide details of usage of the mobile device by an end user that is potentially indicative of a violation of the customer 102 IT policy or Acceptable User Policy. In an embodiment, reports are customized based upon customer policies specified in the customer data store 204. Such reports can be automatically generated and sent to a predetermined customer email address and/or generated upon request. Exception reports 316 are described in further detail below.

The device management system 100 also receives reports of support incidents 318. Support incidents include updates to mobile devices, such as moves, adds, changes, deletions (MACDs), as well as, failure, malfunction, theft or loss of a mobile device. The user interface 202 can include a call center or electronic voice phone system that receives communications reporting support incidents. Reports of support incidents are utilized by the support component 218 to provide assistance to users. In an embodiment, replacement mobile devices are supplied to users experiencing mobile device difficulties. In addition, reports of support incidents are tracked, analyzed and used generate support reports 320. In particular, data related to failure of particular devices is maintained in the asset data store 214. Information regarding mobile device failures and end user problems, as well as responses to such problems, is output in support tracking reports 320.

The device management system 100 receives usage records or billing data and call detail records 322. In particular, usage data from multiple service providers 104 is received and entered into the system 100. This information is maintained in the service provider data store 206 and utilized by the billing component 216 to allocate, monitor, control, or direct billing. In one embodiment, the billing component 216 generates invoices as a function of the provided billing data and call detail records. The invoices can be customized based upon individual customer practices and procedures. For example, costs may be grouped by business unit, rather than by service provider. Additionally, distinct services from a single carrier can be invoiced separately or multiple carrier invoices can be consolidated into one invoice.

The billing component 216 generates one or more reports reflecting billing and usage information. For example, a cost allocation report 324, detailing mobile device expenses, allocates costs by business unit, service provider 104, employee or end user classification or characteristic or any other useful category. In addition, the billing component 216 can generate a call usage detail report 326 providing customers 102 with detailed information regarding use of mobile devices. Such reports can be formatted or organized in any manner useful for the customer 102 and may be customized based upon customer policies. In addition, the billing component 216 generates custom invoices 328 based upon customer policies.

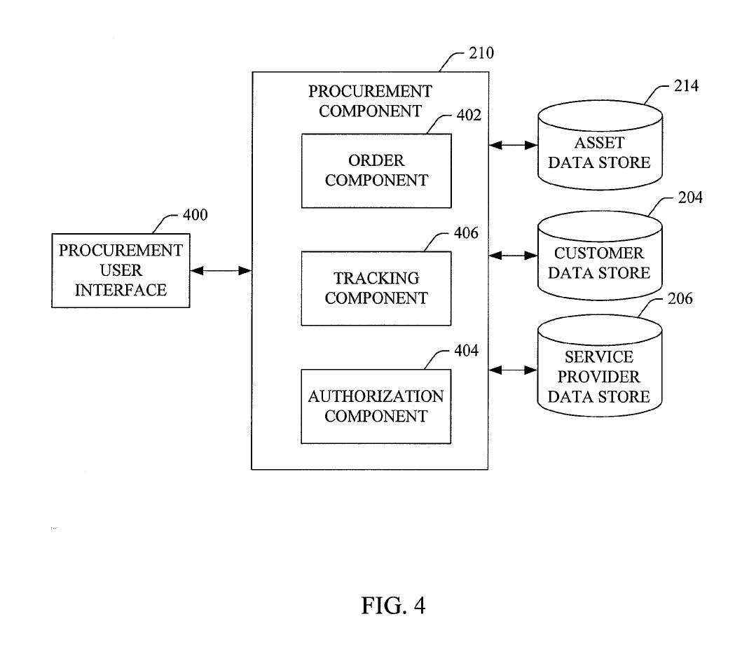

Referring to now FIG. 4, a detailed block diagram of an embodiment of the procurement component 210 is illustrated. The procurement component 210 provides end users with a tool for obtaining mobile devices and services from one or more service providers 104. The procurement component 210 coordinates placement mobile device orders, processing and authorizing of such orders, as well as monitoring shipment and provisioning of mobile devices. In particular, end users interact with the procurement component via the customizable procurement user interface 400. As described above, the procurement user interface 400 can be implemented as a stand-alone user interface, or as a part of a general interface 202 to the device management system 100.

In an embodiment, the procurement user interface 400 is available via a network, such as the Internet. In another embodiment, a graphical user interface (GUI) is provided, allowing users to select from available mobile device and service options. Options are displayed based upon customer policies and service provider data, such as available service plans. In particular, the service plans selected by the customer from one or more service providers affect available options presented to end users. In addition, options presented to individual users vary based upon the user characteristics or traits, including, but not limited to, user business unit, user position within the company or any other relevant characteristic. In an embodiment, the procurement user interface 400 utilizes customer-specific information or policies expressed in the asset data store 214 to provide customized options.

The procurement component 210 includes an order component 402 that manages placement orders of mobile devices. In particular, the procurement component 210 receives information from the procurement user interface 400 regarding selected options and generates one or more order to be communicated to service providers. When configured, the order component 402 can automatically submit secure email orders or requests to the appropriate service provider or service providers.

In another embodiment, the procurement component 210 includes an authorization component 404 that verifies or obtains authorization for an order generated by an end user. Many customers require authorization by specific employees or departments prior to purchase of equipment. The authorization component 404 utilizes the specific authorization procedures of the particular customer 102 with which the user is associated to authorize the purchase order. The authorization process is expressed as a customer policy described in the customer data store. In an exemplary approval process, the authorization component 404 notifies a particular individual or department (e.g., an information technology (IT) department) of the customer 102 with authority to approve orders. In another embodiment, the individual with authority to approve orders varies based upon the particular user placing the order. For example, the customer 102 may require approval of the manager of the user. End user information and customer hierarchy or organization information maintained in the customer data store are used to identify the individual with authority to approve the order. In one embodiment, the authorization component 404 sends an email or other electronic notice to the appropriate authority. In another embodiment, the authorization component 404 generates the appropriate customer forms and sends an electronic or hard copy of the forms to the relevant authorities. Approval or denial can be communicated via a response to an email request, via the procurement user interface 400, or using any other mode of communication.

Once approved, the order is communicated to the appropriate service provider. In an embodiment, the procurement component 210 also includes a tracking component 406 that monitors filling and delivery of the ordered equipment. The tracking component 406 obtains status information regarding the progress and/or estimated date and time of delivery of the mobile device. In addition, the tracking component 406 can track the shipping of the mobile device to the particular user. The tracking component 406 obtains shipping information from the service provider 104 and monitors the progress of the shipment. In an embodiment, the tracking component 406 can notify the user of progress (e.g., time of shipping, estimated delivery date, progress of package) via email, voicemail, text message or any other form of communication. In addition, the user can obtain status information from the tracking component 406 through the procurement user interface 400. Once the mobile device and the order completed, information regarding the asset is stored in the asset data store 214 as a part of the inventory of the customer 102.

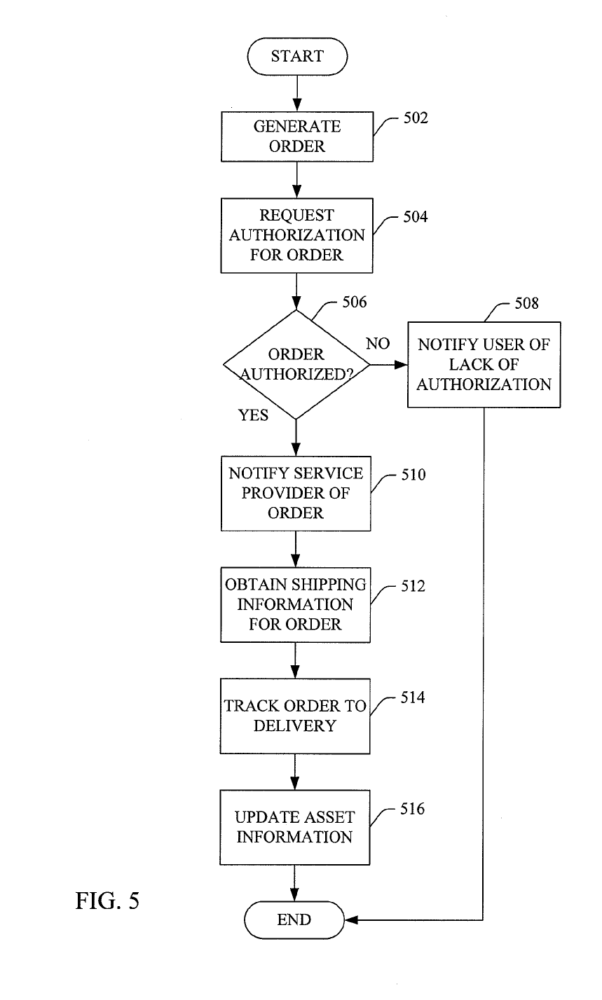

With reference to FIGS. 5, 6, 8, 9, 11, 12, 14-17, flowcharts depicting methodologies associated with management of mobile devices are illustrated. For simplicity, the flowcharts are depicted as a series of steps or acts. However, the methodologies are not limited by the number or order of steps depicted in the flowchart and described herein. For example, not all steps may be necessary; the steps may be reordered, or performed concurrently.

Turning now to FIG. 5, an exemplary methodology for processing a user order is illustrated. At reference number 502, an order is generated by the order component 402 based upon input provided by users through a user interface 202. In an embodiment, orders are generated using customized user interface 202 that ensures that orders comply with customer practices and policies. An order includes data regarding the end user creating the order, the mobile device, including physical device and service plan, requested and the service provider 104 from which the mobile device is to be purchased or supported. In addition, the order can include information such as delivery address, business unit responsible for billing purposes and the like.

At reference number 504, authorization for the order is requested by the authorization component 404. In an embodiment, the individual order or authorization procedures of the customer 102 determine the authorization process. In particular, customer authorization policies are described in the customer data store and used to control order processing. For example, an email can be transmitted to the appropriate party (e.g., manager of the requesting user, IT department, and the like) requesting authorization of the order. In an embodiment, the authorization component 404 utilizes the standard requisition form of the company to request authorization of the order. At 506 a determination is made as to whether the order is authorized. If no, at reference number 508, the user who generated the order is notified that the order has not been authorized and will not be processed. The process then terminates.

If the order is authorized, the service provider 104 is notified and provided with the order information at reference number 508. In addition, the end user may be notified of approval and placement of the order. Once the order is placed, the tracking component 406 obtains tracking and/or shipping information from the service provider 104 at reference number 510. Shipping information can include an estimated time to shipment of the mobile device or devices to fill the order, a tracking number used by the delivery service, an estimated date of delivery, and any other information related to delivery of the mobile device(s). At reference number 512, the tracking component 406 tracks or monitors delivery of the mobile device(s). For example, the tracking component 406 retrieves tracking information from the delivery service, provides users with updates regarding status of the order (e.g., email specifying date shipped and status in transit) and the like. The order component 402 can update asset data store 214 to reflect the addition of new mobile devices or changes to existing mobile device accounts at reference number 514.

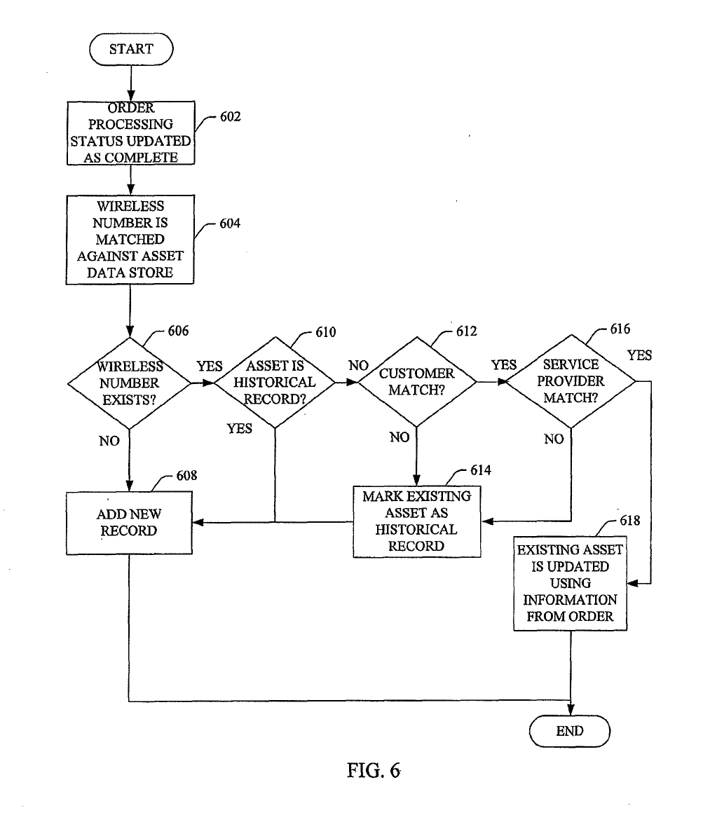

Turning now to FIG. 6, an exemplary methodology for adding or updating mobile device information in the asset data store 214 in response to completion of an order is illustrated. After an order is placed, and the mobile device delivered to the end user, the asset data store 214 is updated to reflect the new information. The mobile device may be provided to an end user that does not have an existing, associated wireless number. For example, a new employee may be provided with a mobile device assigned a new wireless number. Alternatively, an existing end user may replace an existing mobile device associated with a particular wireless number, with a new mobile device. In which case, the new device is to be associated with the pre-existing wireless number in the asset data store 214. In addition, wireless numbers that have been unused for a period of time, becoming historical records rather than active accounts, may be reissued with the new mobile device.

At reference number 602, the status of the order is updated upon delivery of the mobile device to the end user and new mobile device information is to be added or updated in the asset data store 214. At reference number 604, the wireless number assigned to the delivered device is compared to mobile device data maintained in the asset data store 214. In an embodiment, the wireless number itself is used as an identifier for a mobile device. If the mobile device is a replacement for an existing device, the wireless number will already exist within the asset data store 214.

At reference number 606, a determination is made as to whether the wireless number already exists within the asset data store 214. If no, the mobile device is added as a new record to the asset data store 214 at reference number 608, and the process ends with addition of the new mobile device record. However, if the wireless number already exists within the asset data store 214, a determination is made as to whether the record associated with the wireless number is a historical record at reference number 610. Wireless numbers and related data associated with a mobile device that is not in active use are maintained by the asset data store 214 as historical records, preserved for use in analysis, comparison and the like. If the status of the wireless number record in the asset data store 214 is that of a historical record, status is updated to active and the new mobile device is added to the asset data store 214 at reference number 608.

If the wireless number currently exists in the asset data store 214 and is not marked a historical record, then the wireless number is in active use. At reference number 612, a determination is made as to whether the customer 102 indicated in the order matches the customer 102 associated with the wireless number record in the asset data store 214. If no, then the wireless number has been reallocated or transferred from the customer 102 referenced in the asset data store 214 to the customer 102 placing the order. Accordingly, the record in the asset data store 214 is marked as a historical record at reference number 614, since the wireless number is no longer active for that customer. The mobile device is added to the asset data store 214 as a new wireless number record for the customer 102 indicated on the order at reference number 608.

If the customer 102 indicated on the order matches the customer 102 associated with the wireless number in the asset data store 214, then at reference number 616, a determination is made as to whether the carrier or service provider 104 referenced in the order matches the service provider 104 associated with the wireless number in the asset data store 214. If the service provider 104 associated with the order does not match the service provider 104 referenced in the asset data store 214, the wireless number has been transferred from one service provider to another. At reference number 614, the wireless number record in the asset data store 214 is marked as a historical record, and the mobile device in the asset data store 214 is added as a new wireless number record associated with a new service provider 104 at reference number 608.

If the service provider 104 and customer 102 match the information maintained in the asset data store 214 associated with the particular wireless number, then at reference number 618, the wireless number is updated for the new mobile device utilizing information from the order. In this scenario, the physical device has been updated, but there is no need to create a new record since the service provider 104 remains the same.

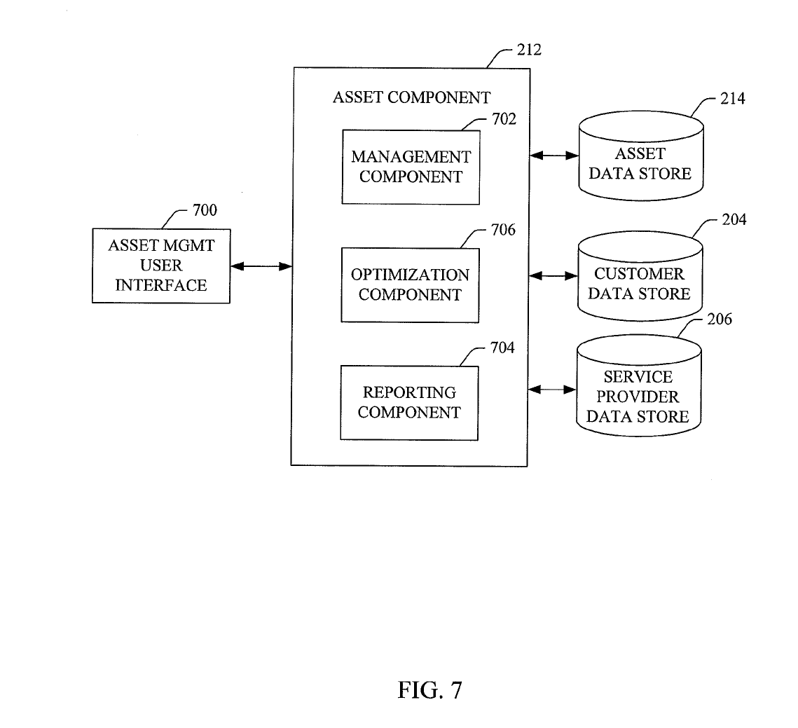

FIG. 7 is a detailed block diagram of an exemplary embodiment of the asset component 212. Users interact with the asset component 212 primarily through an asset management user interface 700. As described above, the asset management user interface 700 can be implemented as a stand-alone user interface, or as a part of a general interface 202 to the device management system 100. The asset component 212 provides detailed information regarding the distribution and use of mobile devices through the organization, which is presented via the customized asset management user interface 700. In an embodiment, users are identified and granted access to mobile device information in accordance with the customer policies, as specified in the customer data store 204. Access may be limited based upon business unit, or function of the end user within the customer (e.g., administrator or salesperson) For example, upper level managers are likely to be granted significantly wider access than end users in sales departments.

In an embodiment, the asset component 212 includes a management component 702 that provides users with the ability to monitor and manage mobile devices associated with the customer 102. The management component 702 may be accessed via the asset management user interface 700 and used to retrieve information regarding one or more mobile devices and/or mobile device usage from the asset data store 214. In another embodiment, the management component 702 has one or more pre-defined queries or data retrieval functions that provide relevant data to users. Data retrieval is limited to assets specific to the customer 102 requesting the data, and may be customized based upon the user requesting the data, business units, organizational hierarchy or other criteria.

The management component 702 modifies records maintained in the asset data store 214, the customer data store 204 and service provider data store 206. In an embodiment, administrators utilize the management component 702, accessed via the asset management user interface 700, to update or correct data in the asset data store 214, customer data store 204 or service provider data store 206. In particular, end user information can change as end users are added, transferred or leave the customer. Similarly, new mobile devices are purchased or leased and existing mobile devices are transferred to other end users or become worn out and are retired. In addition, service plans and customer needs vary over time. Accordingly, end user, mobile device and service provider information maintained in the asset data store, customer data store 214 and service provider data store 206 are updated to reflect these changes.

In another embodiment, updates or modifications by an end user require approval, similar to the approval process required to procure a mobile device. For example, a disconnect of a mobile device, addition or removal of services (e.g., text messaging or international dialing) or a change in user information (e.g., change in position, employment status, business unit or the like) may require approval of the end user's manager. In such cases, customer policies regarding authorization of modifications to end user or mobile device data are retrieved from the customer data store 204 and the appropriate individual or entity is contacted for approval prior to modification of the data within the asset data store 214, customer data store 204 and/or service provider data store 206.

In other embodiments, the management component 702 identifies mobile devices at the end of their lifecycles as candidates for retirement. A report is generated listing candidate mobile devices that have been in service greater than specified period of time. An administrator can select from the list of mobile devices for upgrade or replacement. Upon approval by an administrator, end users are notified of a replacement mobile device, which may be obtained via the procurement component 210, and are required to return the retired mobile devices. The management component 702 can track the return and recycling or destruction of retired devices.

The asset component 212 also includes a reporting component 704 that generates one or more reports regarding customer mobile devices. The reports may be based upon usage of devices, billing for mobile devices or any other statistics. The report data may be collected and filtered for specific business units, individuals, or particular functions or service plans. In an embodiment, the reporting component 704 periodically generates a set of reports, including specific reports directed to executive level end users and mobile device administrators. In another embodiment, the reporting component 704 generates customized reports based upon end user elections input via the asset management user interface 700.

The reporting component 704 provides customers 102 or end users with exception reports 316. Exception reports 316 identify unnecessary or unusual usages, resulting addition or increased service provider charges. In an embodiment, exception reports 316 detail directory assistance charges, equipment charges (e.g., support, replacement or repair fees), and roaming charges. In another embodiments, the exception report 316 lists top users of mobile devices, end users who did not utilize their mobile device at all during the reporting period, and end users that accumulated data charges.

The asset component 212 includes an optimization component 706 that analyzes data associated with a particular customer 102 and generates recommendations to optimize mobile devices based upon customer policies or strategies. Common strategies include minimization of cost to the customer 102 while maintaining necessary functionality. In an embodiment, the optimization component 706 utilizes the statistics collected by the reporting component 704 to identify likely optimization opportunities.

In other embodiments, the optimization component 706 identifies opportunities for reducing costs and provides suggestions or recommendations for optimizing mobile device distribution for the customer 102. The optimization component 706 details the particular steps to minimize cost while maintaining functionality. For example, the optimization component 706 can identify users with the highest overages (e.g., minutes in excess of the amount allotted by the service plan) and recommend switching such users to a service plan without a maximum number of minutes. Similarly, users who consistently utilize only a fraction of the available minutes can be identified for transfer to a service plan with reduced minutes. The optimization component 706 can periodically analyze customer statistics. Alternatively, users can request optimization recommendations at any time, via the asset management user interface 700.

The optimization component 706 is customizable and may be trainable. In an embodiment, frequency of optimization as well as particular statistics for analysis and other features are customizable for the particular customer. In addition, the suggestions or possible optimizations are based upon the particular characteristics of the customer 102. For example, optimizations are based upon standard market offers or deals negotiated by the customer 102 with particular service providers and other customer policies.

In an embodiment, the optimization component 706 includes or consists of artificial intelligence or knowledge or rule-based components, methodologies or mechanisms. For example, the optimization component uses vector machines, neural networks, expert systems, Bayesian belief networks, fuzzy logic, data fusion engines, classifiers or the like. Accordingly, the optimization component is adaptive over time and may become more efficient in identifying opportunities and generating recommendations.

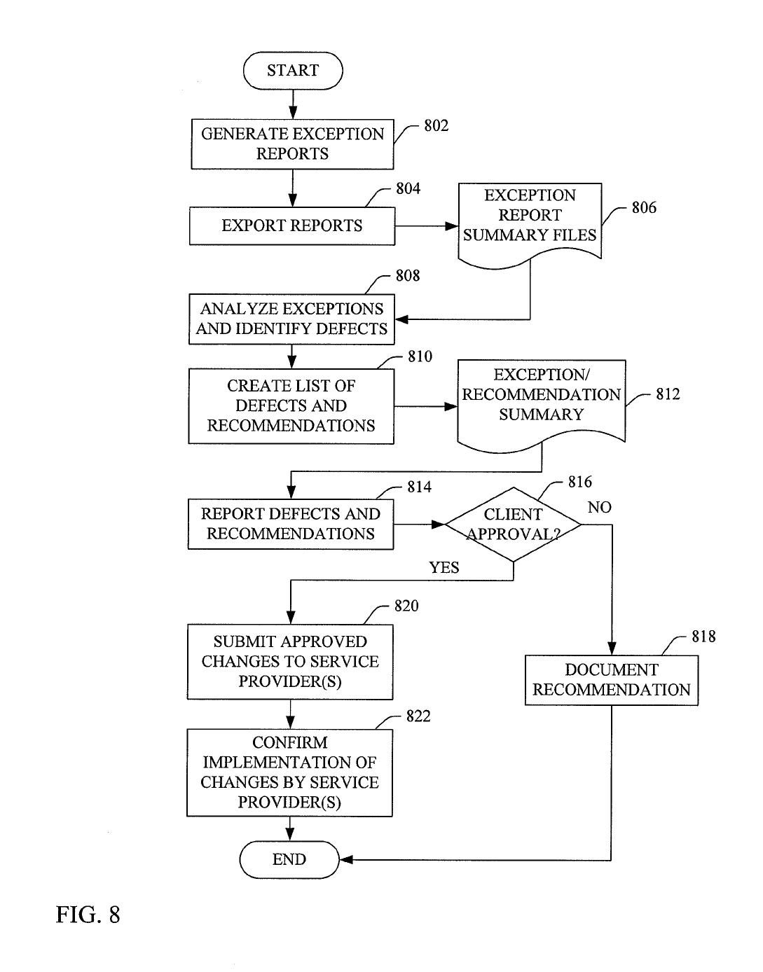

Referring now to FIG. 8, an exemplary methodology for optimizing mobile devices for a customer is illustrated. At reference number 802, one or more exception reports 316 are generated. Such reports identify mobile devices operating outside normal bounds, or mobile devices operating at the extremes. For example, exception reports identify such as the most and least used mobile devices and functions. In an embodiment, exception reports 316 are based upon the most recent billing and usage data. In a further embodiment, historic information regarding billing and usage is obtained, averaged and used to identify exceptions. In yet another embodiment, a weighted average of the most recent billing and usage data as well as historical billing and usage data is utilized.

At reference number 804, the exception reports 316 are exported to either the customer 102, or the customer data store 204. These exception reports 316 are maintained in summary files at reference number 806. At reference number 808, the exception reports 316 and summaries are analyzed to determine defects that indicate possible opportunities for optimization. In an embodiment, analysis includes comparison with predetermined standards of usage, utilization or other statistics. Alternatively, the determination is based upon comparison with historical data, average usage and the like.

Based upon the analysis of charges and identification of defects, a list of defects and associated recommendations for resolving such defects is generated at reference number 810. Recommendations can be customized for the particular customer 102. In particular, the recommendations are based upon the various negotiated plans or options with various service providers. In addition, in certain embodiments, such recommendations are a function of the particular practices and policies of the customer 102, such as options available within business units, and the like. A summary of exceptions and associated recommendations is produced at reference number 812. The resulting exception and recommendation report is communicated to the customer 102 at reference number 814.

The customer approves or ignores the various recommendations. At reference number 816, a determination is made as to whether the customer 102 approves of each of the one or more recommendations. For each recommendation not approved, the suggestion is documented for future reference at reference number 818, but not implemented. For each recommendation approved, the approved change in service is submitted to the appropriate service provider 104 at reference number 820. At reference number 822, the changes to the service plans are confirmed. The optimization process can be repeated periodically, (e.g., on a monthly or quarterly basis) or dynamically triggered by an end user.

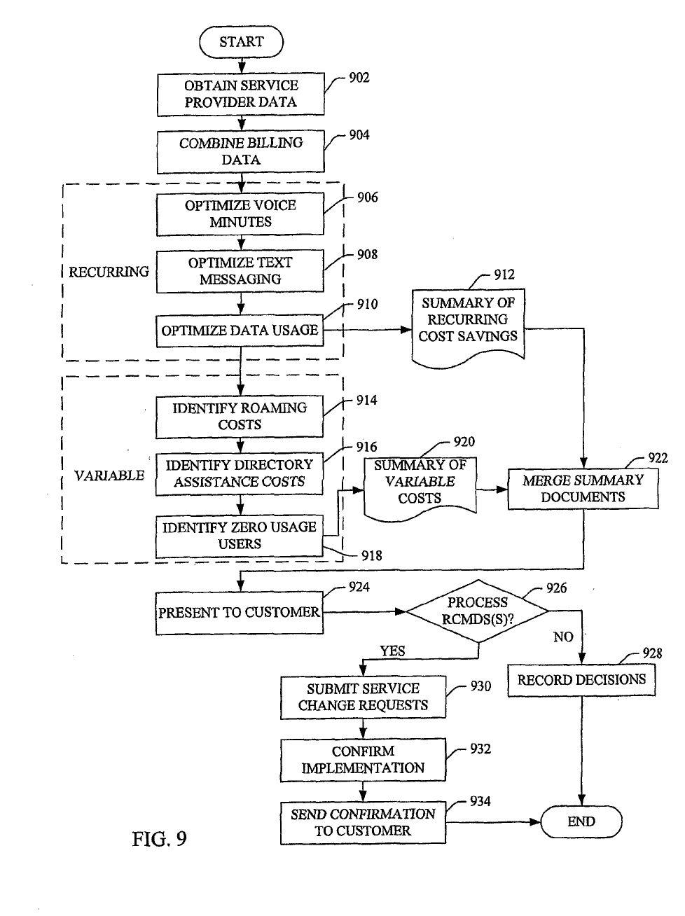

Referring now to FIG. 9, a flowchart depicting an exemplary methodology for optimizing mobile device management by reducing costs is illustrated. At reference number 902, billing and/or usage data is obtained from one or more carriers or service providers. The received data is reformatted and combined at reference number 904. The combined data is analyzed to identify potential optimization of various recurring charges.

Recurring charges are predictable, periodic charges, such as monthly basic cell phone charges. Optimization recommendations to minimize recurring charges based upon actual usage of the services for which monthly charges are accrued are generated. In particular at reference number 906, the optimization component 706 analyzes the combined data to optimize use of minutes for voice communications. For example, a service provider 104 may provide several service plans with different amounts of prepaid minutes. Recommendations for switching between service plans are generated based upon actual use of minutes during the previous period(s). In addition, the optimization component 706 generates recommendations for switching mobile devices between different service providers 104 to minimize overall cost for the customer.

In another embodiment, recurring charges include base fees for text messages or paging service. At reference number 908, the optimization component 706 optimizes text messaging recurring charges. Service providers 104 may provide different service plans that include various numbers of free text messages before applying additional overage charges for text messaging. Recommendations for switching between service plans are generated based upon if the end-user is utilizing text messaging or if they have incurred overage charges during the previous period. In an embodiment, an operator or administrator utilizes the optimization component 706 to review exception reports 316 to identify opportunities for reducing costs and/or optimizing use of text messaging. In an additional embodiment, the optimization component 706 generates recommendations for switching mobile devices to different text messaging plans to minimize overall cost for the customer.

At reference number 910, the optimization component 706 generates recommendations to reduce data usage costs. Many mobile devices provide access to data. For example, many smart phones allow access to email accounts and/or the Internet. Typically, an additional fee is charged for such services. The optimization component 706 evaluates actual usage of the data services to identify opportunities to minimize costs while maintaining useful services. These recurring charges, as well as any other additional recurring charges, are summarized by the optimization component 706 in a summary of recurring cost savings at reference number 912.

In certain embodiments, the optimization component 706 evaluates variable costs and identifies opportunities to minimize costs. For example, at reference number 914, the optimization component 706 identifies instances where users incurred roaming charges. Many service providers 104 charge an extra fee, referred to as a roaming charge, when a user places or receives a call from outside the network of the service provider. The optimization component 706 identifies instances and trends of roaming charges and evaluates the frequency and amount of such charges. The optimization component 706 then generates recommendations based upon the roaming costs. For example, the recommendation may suggest switching the mobile device to a new service plan that would reduce or eliminate roaming fees.

The optimization component 706 also identifies directory assistance costs at reference number 916. Directory assistance fees are incurred when users call the service provider 104 or an operator and request a telephone listing. Recommendations to avoid such costs can include training employees who make repeated calls for directory assistance to avoid such calls.

In another embodiment, the optimization component 706 analyzes the billing and usage data to identify users who did not utilize mobile devices or various mobile device functions in the preceding billing period at reference number 918. Such users may have no need for the device at all, in which case the mobile device can be returned or reassigned. The optimization component 706 may generate a recommendation that the users need for the mobile device be reevaluated. A summary of the variable costs is produced at reference number 920.

The optimization component 706 merges the recurring and variable cost summaries and recommendations at reference number 922. The generated summary includes identified, exceptional costs as well as recommendations to minimize such costs. The summary can be a high-level or detailed report depending upon the requirements of the particular customer 102. At reference number 924, the summary is presented to the customer 102. For example, the report may be presented in a live consultation, and/or automatically generated and transmitted via email on a regularly basis. Alternatively, a printout may be provided on a periodic basis, such as monthly or quarterly. In another embodiment, an administrator associated with the customer logs into the mobile device management system 100 via the Internet and triggers generation of the report. In an embodiment, the report is presented as a static document. Alternatively, the report can be provided using the graphic user interface 202 and allowing users to elect to view detailed, underlying data.

Based upon the response(s) of the customer, a determination is made as to whether to process one or more of the recommendations at reference number 926. The recommendations which are declined are recorded at reference number 928. These recorded recommendations may be used in future analysis of recommendations. In particular, recommendations that are consistently ignored by customer are devalued, with the result that such recommendations are less likely to be generated in the future.

At reference number 930, a service change request is submitted to one or more service providers 104 based upon the approved recommendation(s). In an embodiment, the service change request(s) are submitted by an operator or administrator. Alternatively, the service change requests are automatically submitted by the optimization component 706. After submission of the requests, implementation of the requested changes by the service provider 104 is confirmed at reference number 932. This confirmation is provided to the customer at reference number 934. The process then terminates, but may be repeated periodically. For example, optimization may occur on a monthly or quarterly basis.

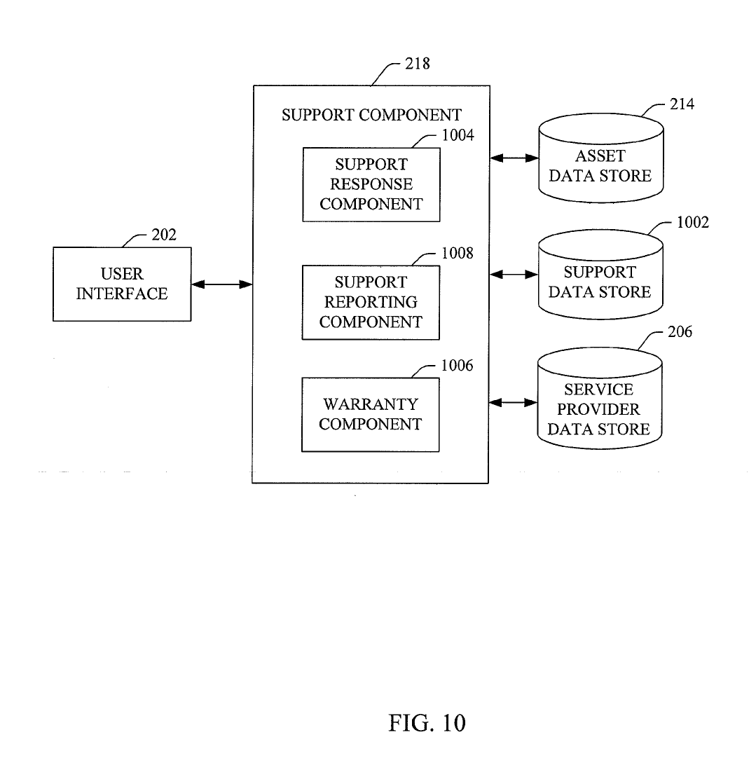

FIG. 10 is a block diagram of an exemplary support component 218. The support component 218 manages assistance for users experiencing problems with a mobile device and provides a central location for assistance regardless of the particular service provider 104 that issued or supports the mobile device. In addition, the support component 218 tracks support incidents, maintaining incident reports in a support data store 1002, and assisting administrators in ensuring adequate support and reducing mobile device problems. In an embodiment, the support data store 1002 is associated with the asset data store 214, providing an exhaustive audit trail detailing the entire support history of a mobile device. In general, users and administrators interact with the support component 218 via the user interface 202. In addition, the support component 218 may be associated with a help desk that provides phone support for users. Either an automated telephone system or help desk personnel may interact with the support component 218, typically via the user interface 202, to provide the users with the assistance required.

The support component 218 includes a support response component 1004 that utilizes data obtained from the asset data store 214 and/or service provider data store 206 to assist users. Support is provided in accordance with customer policy described in the customer data store 204. Support service can include responding to end user questions, troubleshooting problems and/or temporary suspension of services if a mobile device is misplaced. Service may be resumed if the device is located, or the mobile device may be replaced if permanently lost or stolen. In an embodiment, a replacement mobile device is provided to the user when the user's device is damaged, lost or broken (e.g., dropped, immersed in water, and the like). The support response component obtains information regarding the details of the mobile device from the asset data store 214 to ensure that the replacement mobile device has identical or substantially similar functionality. In certain embodiments, the support response component 1004 directs the delivery of the replacement device to the user. Delivery of a replacement may be provided by the operator of the device management system 100. For example, the device management system operator may provide a replacement immediately from an inventory maintained by the operator to ensure rapid response to problems. Alternatively, the support response component 1004 directs the service provider 104 to ship a replacement mobile device to an end user.

In another embodiment, the support component 218 includes a warranty component 1006 that facilitates management of repair and replacement policies of various service providers. In an embodiment, warranty information is associated with the mobile device record in the asset data store 214. In an embodiment, upon request from a user for a replacement, an administrator or operator determines if replacement is truly necessary (e.g., troubleshoots the mobile device) and if necessary, utilizes the warranty component 1006 to generate an order and/or submit the order for the replacement to the appropriate service provider 104. In another embodiment, the warranty component 1006 automatically generates and/or submits forms or paperwork necessary to comply with the various service plans of individual service providers 104. In yet another embodiment, the forms are submitted to the customer 102 for approval, before being submitted to the service provider. Administrators can monitor both receipt of the replacement mobile device, and return of the broken mobile device. In certain embodiments, the warranty component 1006 generates a reminder to ensure that the service provider applies the warranty device replacement credit to the end users invoice.

The support component 218 also includes a support reporting component 1008 that provides administrators with the ability to review requests for support and responses by the device management system operator and/or individual service providers 104. Such support information is important in evaluating service providers 104 and ensuring necessary support is provided. In addition, the support component 218 analyzes the support records to identify trends, such as mobile device models prone to failure or individuals prone to damaging or losing mobile devices. Support records maintained in the support data store 1002 provide an audit trail for a mobile device's support history as well as supporting service level agreement (SLA) performance metrics.

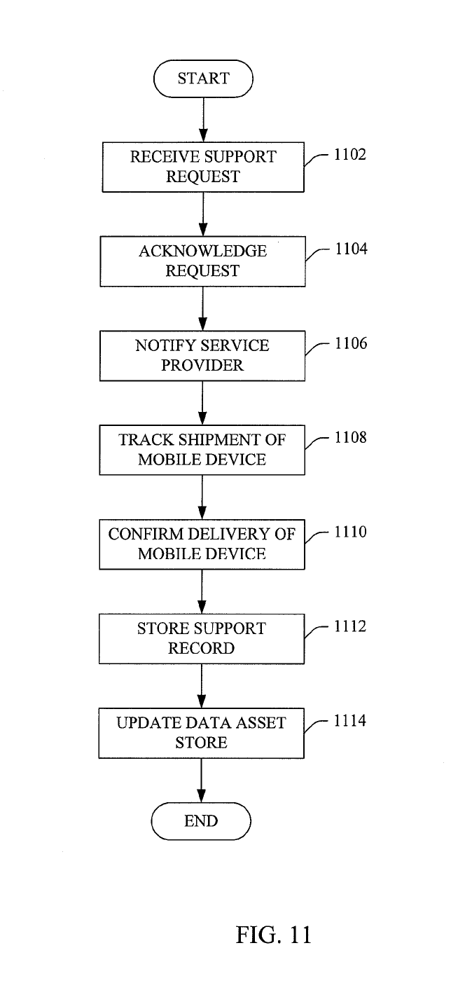

Turning now to FIG. 11, an exemplary methodology for responding to a request for support is illustrated. At reference number 1102 a request for support is received by the device management system 100. The request can be received via the user interface 202, an automated phone system, email, an operator at a help desk or using any other suitable means for communication. A response confirming receipt of the request is communicated to the user at reference number 1104. The response can be transmitted by text message, email, voicemail or any other suitable communication method. In an embodiment, the response includes an estimated time to delivery of a replacement mobile device. In a further embodiment, the device management system operator maintains a stock of mobile devices and ships the devices upon receipt of a support request, enabling rapid response to failure of a mobile device (e.g., delivery of replacement within twenty-four (24) hours of support request).

In another embodiment, at reference number 1106, the support response component 1004 contacts the appropriate service provider 104 to prompt the service provider 104 to respond. In addition, various forms can be submitted to the service provider 104 by the warranty component 1006 based upon warranty or service plan negotiated with the service provider 104. Information regarding the specific requirements for support from a service provider 104 is retrieved from the service provider data store 206.

At reference number 1108, the shipment of a replacement mobile device is tracked by the support reporting component 1008. In an embodiment, the support reporting component 1008 provides status updates (e.g., estimated time to delivery or current location of shipment) to the user awaiting the arrival of the replacement mobile device. Status updates can be provided by email, text messages or any other means of communication. In another embodiment, the user can access the support reporting component 1008 via the user interface 202 to obtain status information.

The delivery of the replacement is confirmed at reference number 1110. All or any portion of the support request and response process is maintained in the support data store 1002 at reference number 1112. Such information is useful in analyzing adequacy of support as well as possible problems in mobile devices or individual usage. At reference number 1114, the support response component 1004 updates the asset data store 214 based upon replacement of the mobile device.

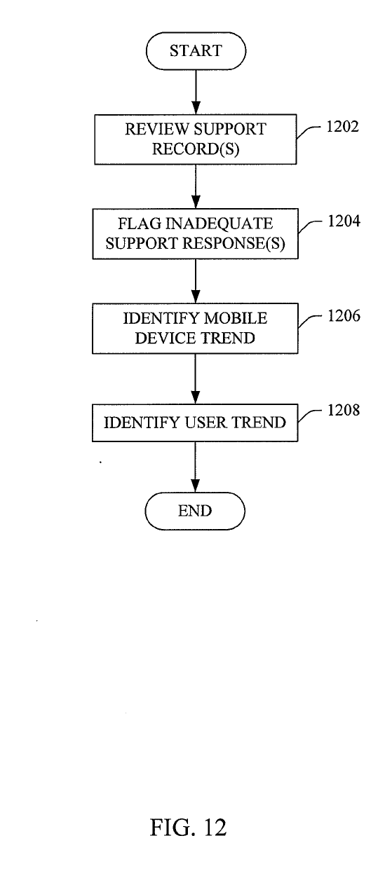

Referring now to FIG. 12, a methodology for monitoring and optimizing provision of support for mobile devices is illustrated. At reference number 1202, support information is reviewed by users or customer administrators. In an embodiment, an administrator can periodically review support records to ensure that effective support is being provided. Alternatively, a report of each support record can be transmitted to an administrator or customer representative at the time of the incident. In another embodiment, an administrator can view support records using the support reporting component 1008 via the user interface 202.

At reference 1204, incidents where support was inadequate or untimely are flagged for attention. Such support records can be emailed to representatives at the customer 102 and or the device management system operator for redress. In addition, statistics regarding support incidents, response and the like can be provided for analysis. At reference number 1206, support records are analyzed and device specific trends are evaluated. In particular, the type of mobile device with the highest failure rate is identified. If the failure rate is out of the normal expected range, a recommendation may be generated to avoid the mobile device. At reference number 1208, user trends are identified. For example, certain users are more likely to damage, lose or destroy mobile devices. Such users may be provided with more rugged devices. Alternatively, such users may be provided with less expensive devices.

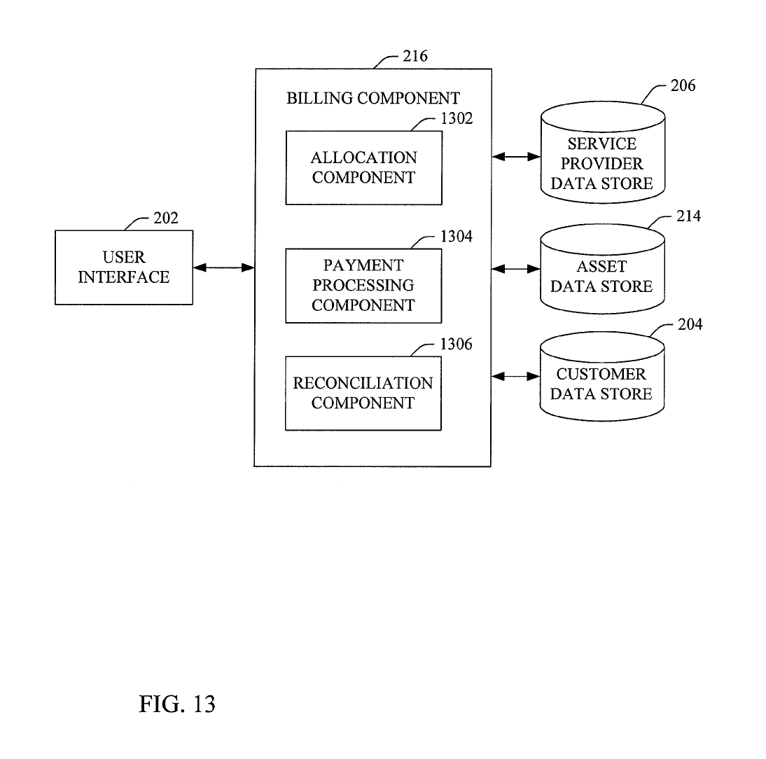

Turning now to FIG. 13, a detailed block diagram of an exemplary billing component 216 is illustrated. The billing component 216 manages billing and usage data received from one or more service providers 104. In one embodiment, the billing component 216 includes an allocation component 1302 that handles cost allocation and invoices, including usage data, received from one or more service providers 104. Data may be received in a variety of formats in electronic files, via an electronic data interchange (EDI) feed, or in any other format utilized by a service provider. Data received from each service provider 104 is parsed, analyzed and reformatted into a standard format utilized by the device management system 100. Data standardization allows for combination and analysis of data from multiple service providers. In addition, the use of a standardized format facilitates the storage, maintenance and analysis of billing and usage data.

In an embodiment, the allocation component 1302 allocates costs from service provider invoices as a function of customer policies. Frequently, customers 102 purchase services (e.g. minutes of voice communications) at the macro or account level to receive the best rates from the service provider. The allocation component 1302 is able to report actual usage as a function of business unit or individual user, facilitating allocation of costs internally for the customer 102. In an embodiment, the allocation component 1302 takes into account all impacted values, such as monthly discounts, taxes and the like. Accordingly, the customer 102 is able to take advantage of cost savings by purchasing services at the organization-wide level, while allocating expenses at the business unit level.

In a further embodiment, the billing component 216 includes a payment processing component 1304 that handles payment of the service provider invoices. For example, the payment processing component 1304 charges customer 102 or even end user credit cards to facilitate payment of service providers. The payment processing component 1304 may utilize customer or end user credit card information maintained in the customer data store 204 to pay service provider invoices. In another embodiment, the payment processing component 1304 distributes paper invoices.

The billing component 216 includes a reconciliation component 1306 that correlates the standardized data received from the various service providers 104 with data maintained in the asset data store 214 and even data from the customer data store 204. The reconciliation component 1306 reconciles the data sets and identifies inconsistencies. In an embodiment, corrective action is taken based upon the identified inconsistencies. Corrective actions include, but are not limited to, removal of inactive mobile devices from the asset data store 214, correction of name mismatches and addition of mobile devices missing from the asset data store 214. In other embodiments, inconsistencies are flagged for further review and can lead to dispute of certain service provider charges. In this manner, the invoice information from service providers 104 is verified prior to payment.

The reconciliation component 1302 is also capable of generating bills based upon the data received from various service providers. In an embodiment, costs are separated based upon functionality. In particular, users may be billed for certain functions (e.g., voice communication charges), while the customer 102 pays for functions required by the customer 102 (e.g., email access). Separate invoices can be generated for individual users, customer business units or third parties.

In another embodiment, costs are allocated to third parties, such as customer clients. This feature is particularly useful where the customer 102 is able to bill a client for phone charges incurred in the process of providing services to the client, such services that require long distance or overseas phone calls. The allocation component 1302 provides the capability to separate out charges based upon mobile number or cost center.

It is understood that various components and subcomponents illustrated in the block diagram figures can be rearranged or reorganized, by one of ordinary skill in the art. For example, the reconciliation component 1306 and allocation component 1302 are shown in FIG. 13 as subcomponents of the billing component 216. However, in an alternate embodiment, the reconciliation component 1306 and allocation component 1302 are separate and distinct components, rather than subcomponents of a billing component 216.

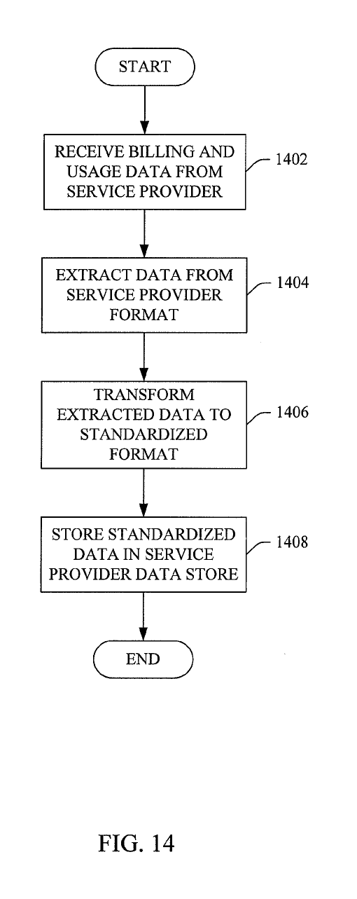

FIG. 14 is a flowchart depicting an exemplary method for transforming service provider information. At reference number 1402, billing and/or usage data is obtained from one or more service providers. The service providers 104 can utilize various methodologies to provide the data, including email, an EDI feed, file transfer protocol (FTP) or any communication means. Once received, the billing and usage data is parsed as a function of the service provider specific formatting to extract billing and usage data at reference number 1404. In particular, the invoice component 1302 obtains format information from the service provider data store 206 and parses the received data in accordance with the format information to extract the desired information.

At reference number 1406, the invoice component 1302 transforms the extracted data into the standardized format of the device management system 100. Transformation can include translation of specific codes utilized by the service provider. This standardized format allows data from separate service providers 104 to be evaluated, compared, and combined. Standardization also allows for storage of the data in a central data store. At reference number 1408, the transformed data is loaded into the service provider data store 206. Maintenance of historic usage and billing information in a standardized format allows for analysis of billing and usage data over time, which may facilitate the identification of trends in usage.

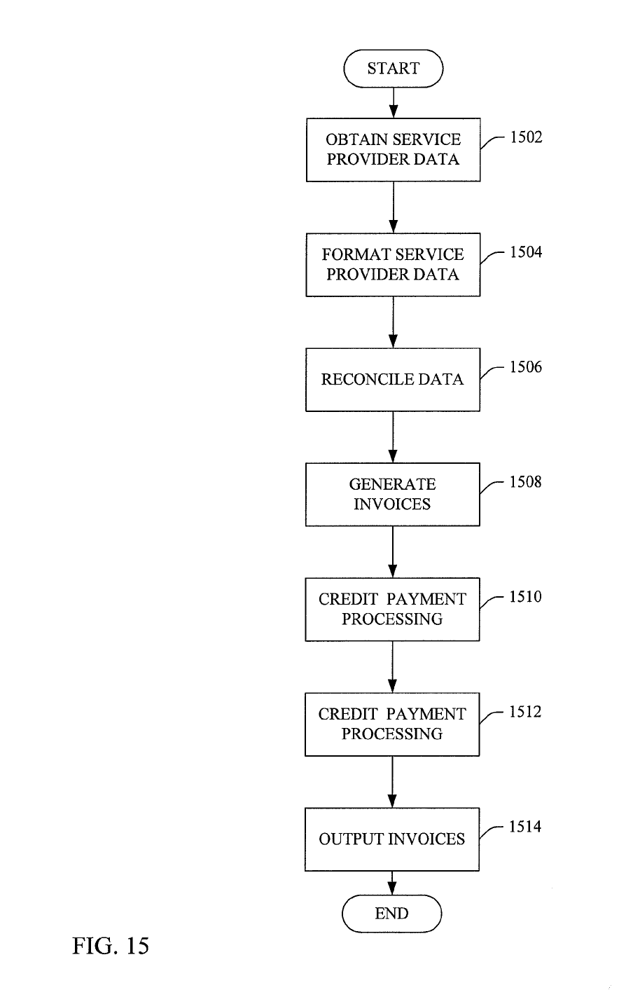

Turning now to FIG. 15, an exemplary methodology for processing service provider invoices is illustrated. At reference number 1502, service provider information is obtained. The information may be the monthly invoices commonly received from service providers. The data may include detailed billing and usage information. The received data is reformatted as standardized data at reference number 1504. In an embodiment, reformatting includes extraction of data from the service provider format, transformation into the standardized format and loading into the service provider data store 206.

The standardized data is reconciled with data maintained in the asset data store 214 at reference number 1506. In one embodiment, the wireless numbers are verified and the services or functions are compared to the service for which the user has subscribed. In another embodiment, the charges are compared to the negotiated rates and service plans. Suspicious, inconsistent or invalid charges are flagged for further attention.

At reference number 1508, the invoice component 1302 generates invoices based upon the received data. The invoices are customized for the particular needs of the mobile device customer 102. In one embodiment, charges are divided and billed based upon business unit. In another embodiment, charges are divided based upon function or service provided (e.g., data access, text messaging and the like), or upon usage. Invoices can be generated for the customer 102, one or more end users or third parties. For example, particular phone numbers are identified as personal use. Charges to such personal numbers are invoiced to the end user rather than the customer 102. In addition, phone numbers for particular third parties, such as clients, can be identified. Charges associated with such third parties may be itemized and the third parties may be invoiced for the particular expenses.

The payment processing component 1304 pays the service providers 104 at reference number 1510. In an embodiment, the device management system 100 may be granted the right to pay undisputed service provider charges. In particular, credit card information for the customer 102 is provided to the device management system 100 and utilized to pay service provider bills. The invoices generated by the invoice component 1302 are output to the appropriate parties (e.g., customer 102, end user(s), or third parties) at reference number 1514. Invoices can be communicated by any appropriate means, including, but not limited to, email, electronic transfer, or printed and delivered by mail.

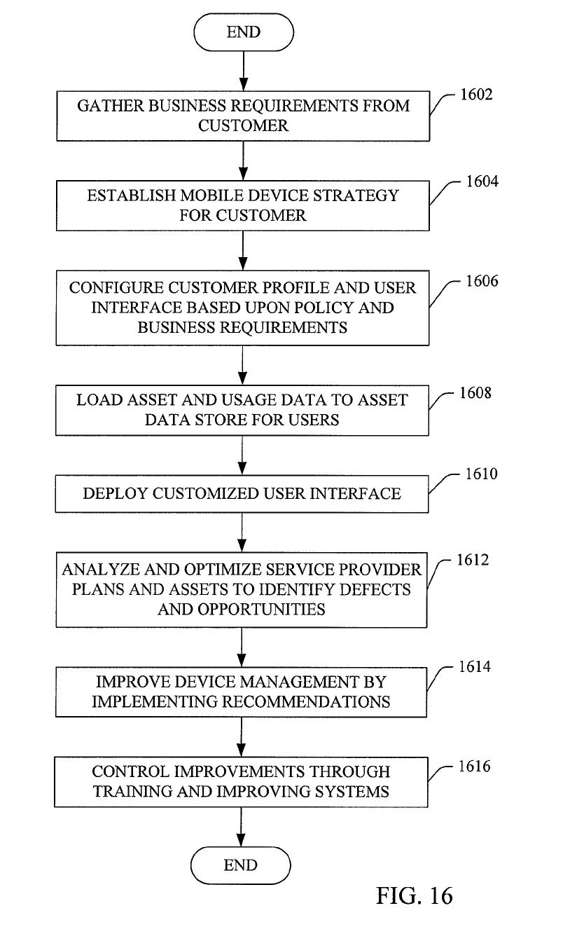

FIG. 16 is a flowchart that depicts an exemplary methodology for configuring the device management system 100 for a customer 102. At reference number 1602, the business requirements of the particular customer 102 are gathered. Such requirements include procurement requirements (e.g., available service providers, devices and service plans) support requirements (e.g., twenty-four hour replacement guaranteed), invoicing or billing requirements (e.g., division of charges based upon function, business unit or the like) and asset management (e.g., description of reports desired by customer 102). Once the customer business requirements are defined, the mobile strategy for the particular customer 102 is established at reference number 1602. The strategy can include minimization of overall costs, distribution of costs over multiple business units. The strategy is composed of one or more priorities. The business requirements and strategies are determined based upon customer interviews, questionnaires, analysis of customer's business and hierarchy and any other customer information. The business requirements and strategy of customers are reflected in customer policies incorporated in the customer data store 204.

At reference number 1606, a customer profile and policies, maintained in the customer data store 204, are configured. In addition, the user interface 202 is updated and customized based at least in part upon customer policies and business requirements as obtained at reference numbers 1602 and 1604. The customized user interface 202 can enforce user policies by selectively restricting access to certain information and functionalities, and by selectively limiting options for election. Access and options may be restricted based upon user, position of user within the customer 102, length of service or any other characteristic as specified in user policies and practices.

Data regarding current users, mobile device, service plans and the like is loaded into the asset data store 214 at reference number 1608. Loading of data includes parsing data records maintained by the customer 102, extracting the data and storing the data in a standardized format utilized by the device management system 100. The customized user interface 202 is deployed at reference number 1610. Once deployed the user interface 202 is accessible to one or more users associated with the customer 102. In an embodiment, the user interface 202 is a centralized web portal that provides for access to one or more tools for managing mobile devices via the Internet.

After the user interface 202 is deployed, the customer 102 can utilize the user interface 202 to manage mobile devices. At 1612, the asset component 212 and/or optimization component 706 analyze the various service provider plans, usage and assets to determine excessive charges or defects that can be resolved to provide opportunities to reduce costs to the customer 102. In one embodiment, analysis and optimization occur when relationship between customer 102 and the device management system 100 is initiated. In another embodiment, analysis and optimization processes are continuous or periodic during the existence of the relationship between the customer 102 and the device management system 100. At 1614, recommendations or corrections for the defects are implemented. In general, recommendations will be approved by a representative of the customer 102. The approved recommendations can be implemented by notifying the appropriate service provider 104 and updating information in the asset data store 214.

At 1616, the recommendations or suggestions for optimization of mobile devices for a customer 102 can be improved by training the device management system 100. As recommendations are accepted or rejected, the device management system 100 learns preferred recommendations. In addition, the device management system 100 can evaluate and analyze the results of implemented recommendations to determine actual affect. In an embodiment, recommendations are weighted based upon projected affect. Weights can be determined from historical information, such as similar previously implemented recommendations.

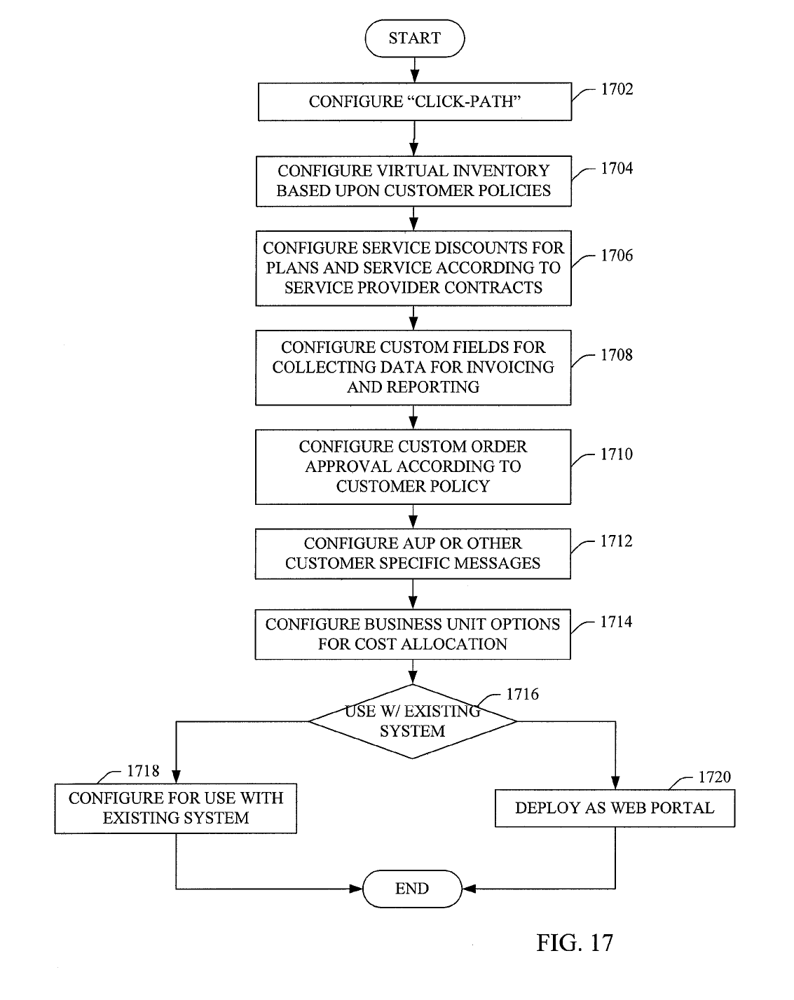

Turning now to FIG. 17, a flowchart depicting an exemplary methodology for configuring the user interface 202 for a particular customer 102 is illustrated. At reference number 1702 the user interface 202 “click-path” is configured. As used herein, the click-path indicates the series of windows or screens with which a user interacts when utilizing the user interface 102, typically by clicking or selecting on buttons on a display screen. Here, the click-path is customized as a function of the policies or requirements of the customer. For example, the customer may require the end user to select the business unit to which they belong before selecting the desired service provider on the following web page.

At reference number 1704, the virtual inventory is configured based upon user policies. Here, the virtual inventory is the inventory of available mobile devices from which an end user can order a mobile device. The particular devices presented as available through the user interface 202 are determined based upon user policies, and may vary based upon user position, business unit, title, or other characteristic. At 1706, data from service providers 104 is used to configure the user interface 202 and device management system 100 for the particular discounts, plans and services the customer 102 has negotiated with one or more service providers 104. Such discounts may affect options provided to users. In addition, such information is used to recommend optimizations.

At 1708, customized fields are added to the user interface 202 for collection of customer specific information. This ability to add fields to the user interface 202 provides the device management system 100 with significant flexibility. For example, nonstandard information can be collected by adding fields to the user interface 202. Introduction of customer specific codes allows customers to track unique or at least uncommon features.

At reference number 1710, the procurement order approval process is customized based upon customer policy. In an embodiment, the customer 102 specifies a multi-tier approval process. For example, end users are restricted in their elections at the user interface 202. Once the user has completed the order request, the generated order is provided to an administrator or other individual or department at the customer 102 with authority to approve the order. The request may be provided in any format suitable for use by the customer 102. In another embodiment, the approval process may be specific to the user placing the order. For example, the user's manager may be required to approve the order.

Additional customer specific information can be added to the user interface 202 at reference number 1712. In one embodiment, the customer 102 provides an Acceptable Use Policy (AUP) that dictates use of the user interface 202. In another embodiment, customer 102 may personalize instructions or other messages to users. At reference number 1714, information regarding the customer's business hierarchy is utilized to generate a model hierarchy. In particular, information regarding, departments, business units, site or locations and the like are used to generate a model of the customer business. This model can be used in invoice or report generation to provide data in a manner that is useful for the customer 102.

At reference number 1716, a determination is made as to whether the user interface 202 will interact with an existing procurement system of the customer's (e.g., Ariba) or whether the user interface 202 will operate as a stand-alone system. If the device management system 100 will interact with an existing procurement system, the user interface 202 is retrofitted to exchange information with the existing system at reference number 1718. Otherwise, at reference number 1720, the user interface 202 is deployed as an independent web portal.

The device management system 100 described herein can be implemented using various combinations of hardware and software. For example, the system 100 can be implemented using a microprocessor, microcontroller, or central processor unit (CPU) chip and printed circuit board (PCB). Alternatively, the system 100 can include an application specific integrated circuit (ASIC), programmable logic controller (PLC), programmable logic device (PLD), digital signal processor (DSP), or the like. In addition, the device management system 100 includes memory, whether static memory, such as erasable programmable read only memory (EPROM), electronically erasable programmable read only memory (EEPROM), flash or bubble memory, hard disk drive, tape drive or any combination of static memory and dynamic memory. The device management system 100 can utilize software and operating parameters stored in the memory. In addition, the user information can be implemented using various combinations of input and output devices, including, but not limited to, a monitor, keyboard, mouse, trackball or other pointer device.

While various embodiments have been described above, it should be understood that the embodiments have been presented by way of example only, and not limitation. It will be understood by those skilled in the art that various changes in form and details may be made therein without departing from the spirit and scope of the subject matter described herein and defined in the appended claims. Thus, the breadth and scope of the present invention should not be limited by any of the above-described exemplary embodiments, but should be defined only in accordance with the following claims and their equivalents.

We claim:

1. A system that manages a plurality of mobile devices associated with a customer, comprising:
a customer data store that maintains customer data comprising a customer policy and end user data related to a plurality of end users associated with the customer;
a service provider data store that maintains service provider data associated with a plurality of service providers, said service provider data comprising at least one service plan offered by said plurality of service providers;
a user interface that provides said plurality of end users and the customer with an interface to the system; and
an aggregation component that utilizes said service provider data, said customer policy and said end user data to enable the customer to manage the plurality of mobile devices used by said plurality of end users.

2. The system of claim 1, further comprising a procurement component that obtains the plurality of mobile devices from said plurality service providers in accordance with said customer policy.

3. The system of claim 2, wherein said customer policy describes an approval process for procuring a mobile device.

4. The system of claim 3, wherein said customer policy further describes at least one available service associated with a subset of end users selected from said plurality of end users based, at least in part, upon a characteristic associated with each of said subset of end users.

5. The system of claim 1, further comprising a billing component that allocates cost associated with the plurality of mobile devices as a function of said customer policy.

6. The system of claim 5, whereby said cost from said service providers is partially allocated to the customer for said plurality of end users, with the remainder allocated to said plurality of end users based, at least in part, upon said at least one service plan provisioned for each of said plurality of end users.

7. The system of claim 5, said cost is allocated based at least in part upon a customer business unit.

8. The system of claim 5, further comprising:
an asset data store that maintains asset data corresponding to the plurality of mobile devices; and
a reconciliation component that reconciles said cost and usage data associated with the plurality of mobile devices with said customer data, said service provider data and said asset data, said cost and said usage data is obtained from said plurality of service providers.

9. The system of claim 8, further comprising a reporting component that generates an exception report detailing exceptions from said customer policy for each of said plurality of end users, based at least in part upon, said cost and said usage data associated with an individual end user selected from said plurality of end users.

10. The system of claim 1, wherein said customer data further comprises usage data that describes use characteristics of the plurality of mobile devices by said plurality of end users.

11. The system of claim 1, further comprising an optimization component that analyzes said customer data in conjunction with said service provider data and generates a recommendation for reducing cost associated with the plurality of mobile devices.

12. The system of claim 1, further comprising a support component adapted to facilitate support for said plurality of end users.

13. The system of claim 1, further comprising an asset component that provides the customer with ability to monitor provisioning and use of the plurality of mobile devices to said plurality of end users.

14. The system of claim 11, whereby a wireless number for each of the plurality of mobile devices is utilized as a device identifier for monitoring the plurality of mobile devices.

15. The system of claim 1, further comprising a means for transforming said customer data into a standardized format for data aggregation and import into an accounting system.

16. A method of managing a plurality of mobile devices for a customer, comprising:
obtaining customer data indicative of a customer policy, said customer policy related to the plurality of mobile devices;
obtaining end user data related to a plurality of end users associated with the customer;
obtaining service provider data associated a plurality of service providers;
deploying a user interface adapted to facilitate management of the plurality of mobile devices as a function of said customer policy, said service provider data and said end user data; and
generating a recommendation to improve management of the plurality of mobile devices in accordance with said customer policy, said end user data and said service provider data.

17. The method of claim 16, further comprising procuring at least one of the plurality of mobile devices via said user interface.

18. The method of claim 17, further comprising authorizing procurement of at least one of the plurality of mobile devices as a function of said customer policy.

19. The method of claim 16, further comprising generating an exception report that provides details of usage of at least one of the plurality of mobile devices, said exception report is indicative of a violation of said customer policy.

20. The method of claim 16, further comprising coordinating support of the plurality of mobile devices from said plurality of service providers for said plurality of end users.

21. The method of claim 16, further comprising allocating cost for the plurality of mobile devices based at least in part upon a service plan associated with each of the plurality of mobile devices.

22. The method of claim 16, further comprising allocating cost for the plurality of mobile devices based at least in part upon a characteristic of each of said plurality of end users.

23. The method of claim 16, further comprising invoicing an individual selected from said plurality of end users for cost associated with a mobile device selected from the plurality of mobile devices, said mobile device is assigned to said individual.

24. The method of claim 16, further comprising aggregating billing for said plurality of service providers.

25. A system for managing a plurality of mobile devices associated with a customer, comprising:
a customer data store comprising a customer policy defining procurement and provisioning preferences of the customer, and end user information pertaining to an end user associated with the customer, the end user information comprising an end user characteristic, an end user historical use data, and an end user provisioning history;
a service provider data store adapted to store service provider data associated with a plurality of service providers, said service provider data comprising a service plan and a mobile device selected from the plurality of mobile devices associated with said service plan;
a user interface adapted to interface with the customer, said user interface includes a means for updating said customer data store and a means for reporting details associated with said service provider data store and said customer data store;
means for providing procurement options to said customer, selected by applying said customer policy and said end user information to said service provider data, said procurement options are presented via said user interface;
means for procuring said mobile device from one of said plurality of service providers and said service plan from one of said plurality of service providers based at least in part upon input received from the customer via said user interface;
means for provisioning said mobile device that activates and provides said service plan and said mobile device to an end user;
means for processing an invoice from said plurality of service providers; and
means for updating said customer data store with details obtained from said invoice for the customer and updating said end user historical use data with details obtained from said invoice.
